(19) United States
(12) Patent Application Publication
(10) Pub. No.: US 2014/0190517 A1
(43) Pub. Date: Jul. 10, 2014

(54) SYSTEM AND METHOD FOR REMOVING SLUDGE FROM A STORAGE TANK

(71) Applicant: TRADEBE ENVIRONMENTAL SERVICES, LLC, Oak Brook, IL (US)

(72) Inventors: James T. Fallon, Carriere, MS (US); James W. Miller, III, Houston, TX (US); Sergio Nusimovich, River Forest, IL (US)

(73) Assignee: TRADEBE ENVIRONMENTAL SERVICES, LLC, Oak Brook, IL (US)

(21) Appl. No.: 13/736,136

(22) Filed: Jan. 8, 2013

(51) Int. Cl. B08B 9/093

(52) U.S. Cl. CPC B08B 9/0933
USPC 134/18; 134/169 R; 134/113; 134/115 G

(57) ABSTRACT

The system and method permits the use of equipment that is located exterior to a container, such as a tank container liquid hydrocarbon material within which a sludge deposit has accumulated, and then inserted, as through an access opening in the side of the tank. In addition to other innovations, an improved hydraulic equipment positioning arrangement is provided, for both positioning, inserting and withdrawing the conduit structure and end effectors for accessing the sludge or sediment, which may include a leveling element preferably in the form of an hydraulic system that operates to move the assembly in a vertical plane as well as a rotary driven hydraulic system for driving the conduit structure along a long axis.

### BACKGROUND OF THE INVENTION

The present invention generally relates to a system and method for the removal of sediment, or sludge, from a container, such as a large tank used to store hydrocarbon fluids. Such tanks would typically be the kind that are used in petroleum refineries or chemical plants, for storing large quantities of hydrocarbon liquids such as crude oil and derivatives thereof.

These types of hydrocarbon liquids will often contain particulates and different phases which may cause layering or stratification. Over time, these particulates and heavier phases accumulate on the floor or base of the tank, forming a sludge. Sludge and sediment are used interchangeable herein. When the accumulation becomes more than tolerable, i.e., excessive, then the sludge must be removed.

It is known to remove the sludge by agitating the sludge in a manner to suspend the sludge in a form where the sludge can then be sucked out of the tank. This can be done by injecting a working fluid into the sludge in the tank, to thereby suspend the sludge in the working fluid, with the entrained sludge then being removed.

Sludge removal can be done manually, as by lowering the liquid in the tank to the sludge layer, and then inserting laborers into the tank to effect removal. This is undesirable from the standpoint of having to place workers within the environment of the tank, but also because the tank must necessarily be taken out of operation during the sludge removal process.

### SUMMARY OF THE INVENTION

The present invention incorporates a number of innovations, many of which are separately novel, but also novel in their various combinations, particularly taken altogether as a single integrated system and method.

Advantages of the present invention include the ability to perform tank cleaning and sludge removal without taking the tank out of service. Use of the term “tank” is not to the exclusion of other types of large-volume containers, but is meant to include without limitation large containers within which sedimentary deposits and the like, such as sludge, would accumulate in the bottom, and particularly such tanks as are used to store crude oil, slop oil and other grades of crude, gasoline, and other hydrocarbon liquids.

Another significant advantage of the present invention is its ability to extract and process sludge containing catalyst fines. This is sludge that builds up in tanks or vessels that contains crude oil fractions and fine particles resulting from erosion of catalysts normally used in oil refinery processes. These particles are highly abrasive and difficult to mobilize or fluidize with normal pumping systems.

Another advantage of the present invention is that entry to the tank by workers is not required. The system and method permits the use of equipment that is located exterior to the tank, and then inserted, as through an access opening in the side of the tank. In association with the foregoing advantage, the present invention further provides an improved hydraulic equipment positioning arrangement, for both positioning, inserting and withdrawing the conduit structure and end effectors for accessing the sludge or sediment. This further may include a leveling element preferably in the form of a hydraulic system that operates to move the assembly in a vertical plane.

Yet another advantage is that the contents of the tank need not be pumped down to the level of the sediment or sludge, in order to remove the latter. In conjunction with the foregoing, a sonar mechanism is preferably provided as part of the system, which is used to take readings to map the topography of the sediment. In operation, this may be done on a periodic basis during the course of sediment removal, in order to direct operations and track progress. This would further allow the use of more directionalized handling of the sludge removal equipment, such as aiming of the end effectors. End effectors may include directional nozzles, as would be used to direct working fluids, for sludge breakup, dissolution and better location of pumping systems.

Still another perceived innovation of the present invention is the use of a single high pressure hydraulic fluidization pump to operate the working fluid. This improves upon the prior art system of multiple pumps and hydraulic pack systems.

As a particularly useful end effector, the improved system and method may employ a Penberthy nozzle. This is used to increase turbulence, as the nozzle effects spraying, mixing and pumping of the working fluid and entrained sludge, essentially simultaneously. Another type of end effector contemplated would be directional nozzles as well, as articulation nozzles. These would most preferably be part of a modular arrangement, whereby a desired end effector could be readily added in place of another.

Yet another innovation of the present invention is the use of a pump grinder mechanism. The pump grinder allows for grinding of sludge solids in the pumping process. Still further, a positive displacement piston pump may be employed in conjunction with the pump grinder.

In one variant of the present invention, the system and method may further include a separate fluidizing mechanism which is emplaced through the top of the tank, in conjunction with the side-entry assembly previously described above. This would be a so-called floor mounted or floor positioned mechanism that would be lowered into position from the top of the tank, and would provide additional fluidization of the sediment, as from the center of the tank outward.

In still another variation, the system and method may further include the employment of a heat exchanger to heat up paraffin and heavy hydrocarbon fractions for fluidification and easier removal and transport.

In still another variation the system and methodology may include a system composed of a dosing pump and related dosing tank or container to add chemicals, as in the supply of working fluid, to further assist in fluidizing the sludge or reducing its viscosity. These products may include dispersants or cutter products such as LCO (Light Cycle Oil).

In accordance with one aspect of the invention, a system and method for removing sediment from a storage container is provided, the storage container having an access opening through a side of the container, through which the bottom of the container can be reached. A concentric pipe member having an inner pipe surrounded by an outer pipe is used in this embodiment. The inner pipe is generally spaced from the outer pipe to create a generally annular open region or conduit therebetween. A supply of working fluid communicates with the inner pipe. The supply of working fluid is provided to the inner pipe under positive pressure.

The inner pipe has a distal end, to which a nozzle is releasably attachable to the distal end of the inner pipe. The outer pipe has at least one distal opening, with a source of negative pressure being applied to the outer pipe to remove material from the container through the foregoing annular conduit.

A length of the concentric pipe member including the inner pipe distal end and the outer pipe distal opening is insertable through the access opening into the container. To that end. a platform carries a portion of the concentric pipe member, and the platform includes a pipe drive mechanism tor moving the concentric pipe in a horizontal direction generally along a long axis of said concentric pipe. The pipe drive mechanism includes at least one rotary element engaging an exterior wall of the outer pipe, and a drive motor for driving the rotary element.

The platform further includes a platform drive mechanism for adjusting the height of the concentric pipe in a vertical direction. Preferably, the pipe drive mechanism and the platform drive mechanism are both hydraulic drive mechanisms, and most preferably use a single source of hydraulic pressure with both drive mechanisms.

In one embodiment, the pipe drive mechanism includes a roller as the rotary element which engages the outer pipe, and most preferably includes a pair of opposed rollers, one roller being located above the outer pipe and the other roller being located below the outer pipe, both rollers being drivable by the pipe drive mechanism to move the concentric pipe member.

A preferred embodiment employs a Penberthy nozzle, and most preferably provides a plurality of different nozzles, such as an articulation nozzle, a Butterworth nozzle, a full stream nozzle and more, which are interchangeably attachable to the inner pipe distal end.

In another aspect of the invention, the system and method further includes a solids grinder mechanism. The grinder mechanism is located in communication with an outflow from the outer pipe and is operated to reduce the size of particulate material entrained in the outflow.

In still another aspect of the invention, the system and method further includes a ranging apparatus, such as a sonar or radar apparatus, which can be installed outside the tank or into the liquid phase in the container, and operated to penetrate to the surface of a sediment deposit in the bottom of the container. A controller for the ranging apparatus is operated in a manner to generate a topographical representation of the sediment deposit.

In still another aspect of the invention, the system and method further includes one or more centrifuges, such as those supplied by Flottweg SE, Vilsbiburg DE, (model Z3), after the grinder pump and heat exchanger. These centrifuges can separate two or three phases from the extracted contents from the tank or vessel, being, in the ease of two phases, solids and oil; and, in the ease of three phases, oil, water and solids. The separate oil can thus be reinjected into the vessel through the above mentioned nozzles.

In still another aspect of the invention, the system and method further includes instrumentation to monitor the process and the different elements. This instrumentation can include: temperature indicators, flow meters, and pressure indicators. These instruments are linked to a programmable logic controller (PLC) that in a typical application can provide information for the process such as total volume extracted, total volume pumped, temperatures in different points, pressures in different points, and relate that data to the topographic data from the sonar system to provide a full real time report to the user. The system also includes all those signals from the pumps and centrifuges including flow, temperature, and speed. The PLC can also be used to adjust flows and speeds so that the whole process is fully integrated. The system may use, for example, a Screen Master monitoring, analytic and display system made by ABB Group, Zurich, CH. This provides real-time information to the user.

These and other modifications, advantages, objectives and details of the present invention will be further understood and appreciated upon consideration of a detailed description of an embodiment of the invention, taken in conjunction with the drawings, in which:

### BRIEF DESCRIPTION OF THE DRAWINGS

FIG. 1 shows in somewhat schematic view, an embodiment of the present invention employed for removing sludge from a large tank;

FIG. 2 is an elevational view of a portion of the embodiment of FIG. 1;

FIG. 3 is a front view of part of the mechanism illustrated in FIG. 2:

FIG. 4 is an elevational view showing some of the hydraulic elements as applied to a lifting platform of this embodiment of the invention;

FIG. 5 is a perspective view similar to that of FIG. 3 showing some of the hydraulic elements for driving the piping;

FIG. 6 illustrates one type of nozzle for use with this embodiment:

FIG. 7 is a schematic view of an entire system and method of an embodiment of the invention; and

FIG. 8 is a side schematic view of a type of heat exchanger useful with the system and method.

### DETAILED DESCRIPTION OF AN EMBODIMENT OF THE INVENTION

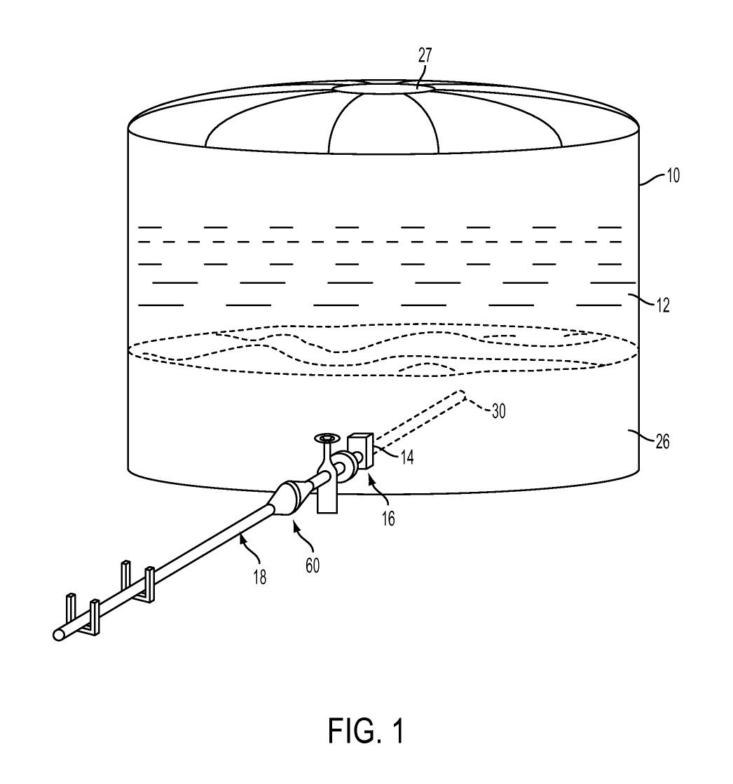

Turning now to FIG. 1, the system is shown as it would be used with a large tank, such as one that would contain a liquid hydrocarbon material: in this particular application, the storage tank 10 contains crude oil 12. Such a storage container would typically have an access opening or manway 14 with a gate valve assembly (broadly indicated at 16) associated therewith. The access opening and gate valve assembly are standard, typically also having an isolation barrel secured to the gate valve with appropriate flanges, secured in a suitable manner. See, for instance, the disclosure of U.S. Pat. No. 6,142,160 with regard to such standard details.

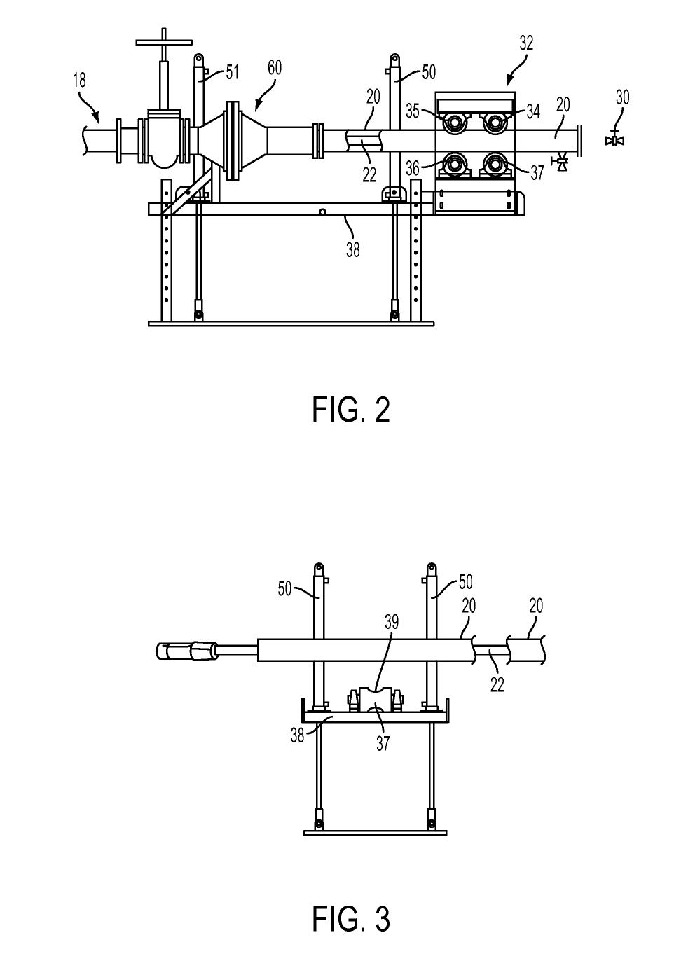

As will be described more specifically hereafter, the inventive system utilizes a concentric piping arrangement 18 having inner 20 and outer 22 pipes (FIG. 2). Piping 18 is inserted through the gate valve assembly 16 into the tank 10, at a level where the end of the piping will be in, or in the vicinity of, sediment or sludge 26 in the bottom of the tank 10.

Turning now to FIG. 2, concentric piping 18 has inner and outer pipes 20, 22 arranged in a known manner. The extended length of the piping will utilize inner and outer joints for interconnection of the respective pipes, as well as appropriate elements to maintain the pipes in spaced relationship. Working fluid will flow through inner pipe 20 out of distal or discharge end 30 into the tank 10, while material, such as fluidized entrained sludge, will flow out of the tank 10 through the outer pipe 22.

In this embodiment of the inventive system and method, a pipe pull and removal station 32 is used to facilitate insertion and removal of the piping 18. Station 32 has upper rollers 34, 35 and lower rollers 36, 37. The rollers have a central groove 39 (FIG. 3) to cradle the outer pipe 22.

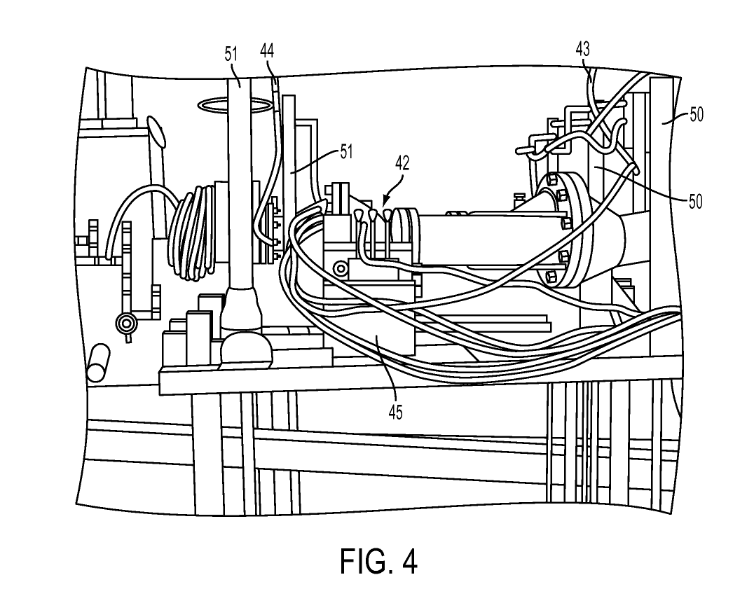

Station 32 is fixed to a movable platform 38. Platform 38 is raised and lowered using an hydraulic mechanism 42, belter illustrated in FIG. 4. Using an hydraulic pump (not shown), hydraulic fluid is applied via lines 43, 44 to a pair of distal cylinders 50 and proximal hydraulic cylinders 51 (distal is relative toward the tank, or forward part: proximal is away from the tank, or rearward part). Controls for operating the height adjustment mechanism are illustrated at 42.

The hydraulic mechanism 42 is also used to drive the upper and lower rollers 34, 35 and 36, 37. Upper rollers 34, 35 have a hydraulic drive 54 for rotation, while lower rollers 36, 37 have a hydraulic drive 55 for rotation.

Returning now to FIG. 2, the system further includes a packing gland assembly generally indicated at 60. This gland assembly includes block valves and a fluid drain system, as well as packing gland adjustment devices, which are conventional. Again, see the aforementioned U.S. Pat. No. 6,142,160.

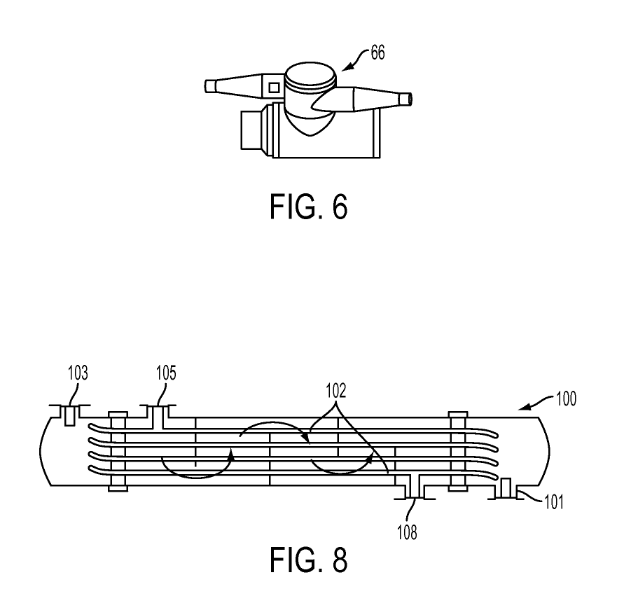

End effectors for the discharge end of 30 of the piping are varied in this embodiment. They may include a variety of different nozzles, such as spray nozzles of suitable configuration, which may preferably be attached and removed in interchangeable fashion, as by a threaded screw-on attachment. One nozzle may be a circulating tank, eductor type, which has the operating fluid leaving the nozzle in a spray pattern to agitate and mix with the sludge in a discharge flow. One particular type of nozzle used in an embodiment of this invention is a Penberthy type circulating tank eductor nozzle, which can come in various sizes and shapes. These Penberthy nozzles arc available from Pentair, of Genesee, Ill. Another type of nozzle would be a directional nozzle, such as the Butterworth type shown in FIG. 6 generally indicated at 66. This is a nozzle that provides 360° of indexing movement, spray or jet, and is supplied by Butterworth. Inc. of Houston, Tex.

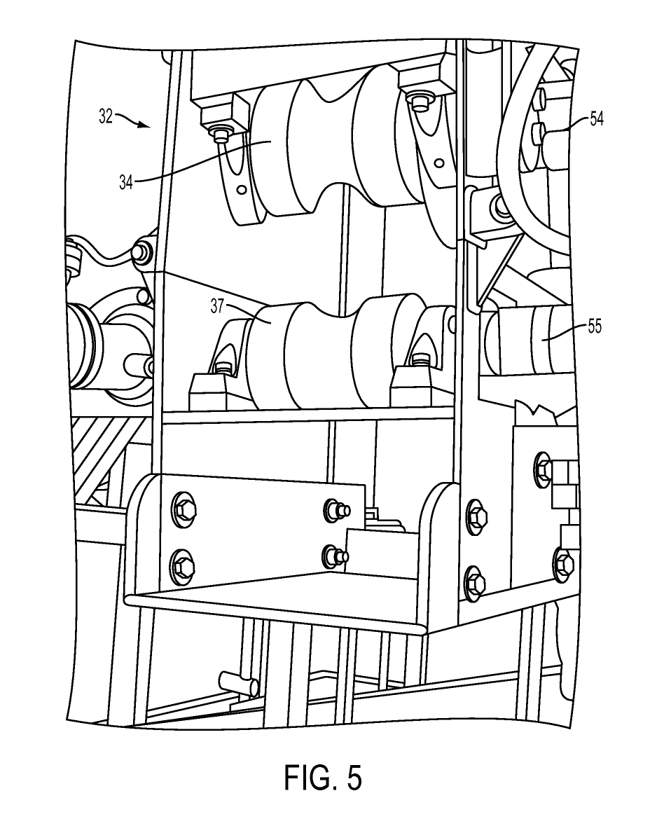

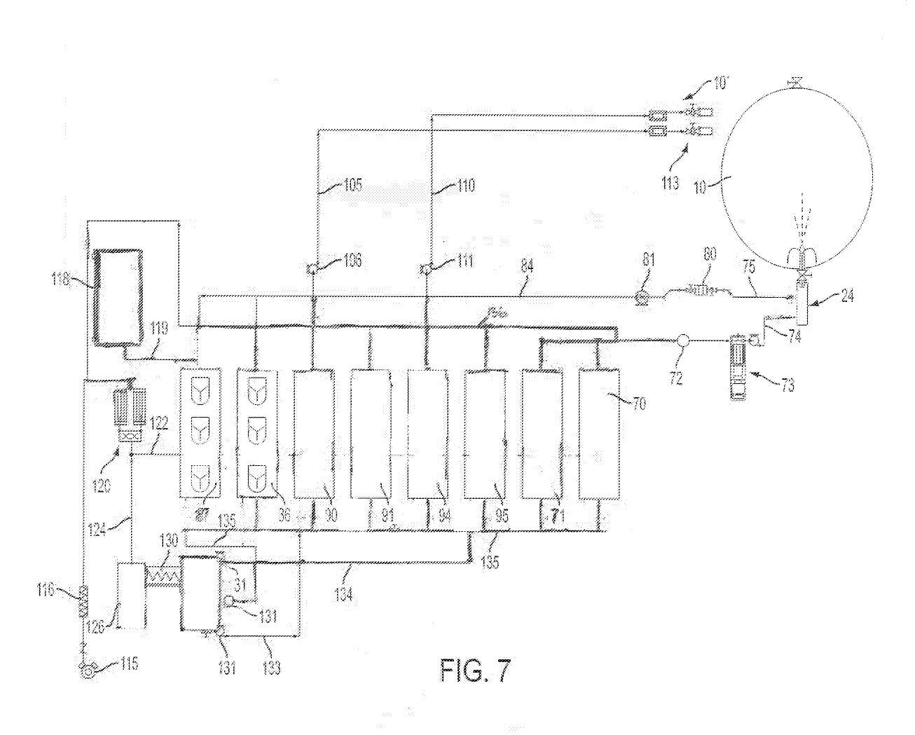

Turning now to FIG. 7, a schematic arrangement for this embodiment of the inventive system and method is illustrated. The elements of the system previously described with reference to FIGS. 2 through 5 in particular, are generally indicated at 24. From an upstream standpoint, working fluid, sometimes referred to as cutter fluid, is stored in cutter tanks 70, 71. The cutter fluid is fed under pressure through line or hose 74 to the interior of the inner pipe 20 in a controllable manner. An inline backer pump 72 is provided, along with a Ruff unit 73 which is a fluidization pump unit and includes the hydraulics.

Fluid and entrained sludge which has been sucked into the outer pipe 22, using a suction pump mechanism, such as a poppet pump, which is a positive displacement hydraulic pump, passes through line or conduit 75, to a solids grinder pump and positive displacement pump 80. This grinder pump, such as one supplied by JWC Environmental is used to grind or reduce the particulate size of solids in the removed sludge. Element 81 is a pilot operated hydraulic relief valve.

From the grinder pump 80, the entrained sludge then progresses through line or conduit 84 to mixing containers 86, 87. The entrained sludge is mixed with cutterstock or other dilutant in containers 86, 87, with the mixture then progressing to oil reclamation containers 90, 91 and water reclamation containers 94, 95.

From the reclaim oil containers 90, 91 reclaimed oil flows through piping 105, using pump 106, to a reservoir or other storage/output for same, indicated at 107. Likewise, reclaimed water flows through piping 110, using pump 111, to a reservoir or other storage/output for the water, indicated at 113.

A water supply 115, such as a fire hydrant, has a filter 116, and piping to feed a boiler 118 and condensate return tank. This is a source of steam, for instance, with a steam supply line 119.

There is a wet scrubber with vapor carton beds and discharge blower indicated at 120. Here high pressure (e.g., 346 psi) hoses 122 connect with the scrubber, including a hose 124 from a solids bin 126. An auger 130 connects from a number of centrifuge pumps 131, with centrifuge oil out line 133 and centrifuge water line out 134. A centrifuge line in from the mix tanks is indicated at 135, 136 is a rerun line.

In a variation, the system and method may further include the employment of a heat exchanger to heat up paraffin and heavy hydrocarbon fractions for removal and easier transport. These heat exchangers may include shell and tube type or spiral heat exchangers, heated with steam. This is shown in FIG 8. FIG 8 illustrates a typical kind of beat exchanger 100. Fluid is introduced at a fluid inlet 101, which then passes through tube baffles 102, to an outlet 103. Shell inlet 106 provides an entrance for a flow that then passes through and around the tube baffles, to a shell outlet 108.

Yet another variation may further include a separate fluidizing mechanism which is emplaced through the top of the tank, in conjunction with the side-entry assembly previously described above. This would be a so-called floor mounted or floor positioned mechanism (not shown, but generally known in the trade) that would be lowered into position from the top of the tank, as through top access opening 27, and would provide additional fluidization of the sediment, as from the center of the tank outward.

Thus, while the invention has been described with respect to a particular embodiment or embodiments, and in one type of environment, it will be appreciated and understood that these are considered to be illustrative examples, and not limiting, Those of skill will recognize modifications, substitutions, changes and other variations which will still fall within the spirit and scope of the invention, which is as set forth in the following claims.

What is claimed is:

1. A system for removing sediment from a storage container, the storage container having an access opening through a side of the container, through which the bottom of the container can be reached, comprising:
a concentric pipe member having an inner pipe surrounded by an outer pipe, said inner pipe being generally spaced from said outer pipe to create a generally annular open region therebetween;
a supply of working fluid communicating with said inner pipe, said supply of working fluid being provided to said inner pipe under positive pressure;
said inner pipe having a distal end;
a nozzle releasabiy attachable to said distal end of said inner pipe;
said outer pipe having at least one distal opening, with a source of negative pressure being applied to said outer pipe to remove material from the container;
a length of said concentric pipe member including said inner pipe distal end and said outer pipe distal opening, being insertable through said access opening into said container;
a platform carrying a portion of said concentric pipe member, said platform including a pipe drive mechanism for moving said concentric pipe in a horizontal direction generally along a long axis of said concentric pipe, said pipe drive mechanism including at least one rotary element engaging an exterior wall of said outer pipe and a drive motor tor driving said rotary element; said platform further including a platform drive mechanism tor adjusting the height of said concentric pipe in a vertical direction.

2. The system of claim 1, wherein said pipe drive mechanism and said platform drive mechanism are both hydraulic drive mechanism, and a single source of hydraulic pressure being provided for use with both drive mechanisms.

3. The system of claim 2, wherein said pipe drive mechanism includes a roller as said rotary clement which engages said outer pipe.

4. The system of claim 3, wherein said pipe drive mechanism includes a pair of opposed rollers, one roller being located above said outer pipe and the other roller being located below said enter pipe, both rollers being drivable by said pipe drive mechanism to move said concentric pipe member.

5. The system of claim 1, wherein said nozzle is a Penberthy nozzle.

6. The system of claim 5, wherein a plurality of different nozzles are provided, said nozzles being interchangeably attachable to said inner pipe distal end.

7. The system of claim 1, further including a solids grinder mechanism, said grinder mechanism being located in communication with an outflow from said outer pipe and operated to reduce the size of particulate material entrained in said outflow.

8. The system of claim 1, further including a ranging apparatus, said ranging apparatus being operated to penetrate to the surface of a sediment deposit in the bottom of the container, and a controller for said ranging apparatus to operate said ranging apparatus in a manner to generate a topographical representation of said sediment deposit.

9. The system of claim 8, wherein said ranging apparatus uses sonar.

10. The system of claim 9, wherein said ranging apparatus uses radar.

11. The system of claim 1, wherein said sediment is a hydrocarbon sludge from crude oil.

12. A method for removing a hydrocarbon sludge from a crude oil storage container, the storage container having an access opening through a side of the container, through which the bottom of the container can be reached, comprising the steps of:
providing a concentric pipe member having an inner pipe surrounded by an outer pipe, said inner pipe being generally spaced from said outer pipe to create a generally annular open region therebetween;
supplying a working fluid communicating with said inner pipe, said supply of working fluid being provided to said inner pipe under positive pressure;
said inner pipe having a distal end;
providing a nozzle releasably attachable to said distal end of said inner pipe;
said outer pipe having at least one distal opening:
supplying a source of negative pressure to said outer pipe to remove material from the container;
inserting a length of said concentric pipe member including said inner pipe distal end and said outer pipe distal opening through said access opening into said container;
providing a platform carrying a portion of said concentric pipe member, said platform including a pipe drive mechanism for moving said concentric pipe in a horizontal direction generally along a long axis of said concentric pipe, said pipe drive mechanism including at least one rotary element engaging an exterior wall of said outer pipe and a drive motor for driving said rotary element, said platform further including a platform drive mechanism for adjusting the height of said concentric pipe in a vertical direction;
forcing pressurized working fluid through said inner pipe and out said nozzle in a manner to agitate and fluidize the sludge;
withdrawing fluidized sludge through said opening of said outer pipe; and
moving said concentric pipe using each said drive mechanism variously to effect removal of sludge from the container.

13. The method of claim 12, wherein said pipe drive mechanism and said platform drive mechanism are both hydraulic drive mechanisms, and a single source of hydraulic pressure is provided for use with both drive mechanisms.

14. The method of claim 13, wherein said pipe drive mechanism includes a roller as said rotary element which engages said outer pipe.

15. The method of claim 14, wherein said pipe drive mechanism includes a pair of opposed rollers, one roller being located above said outer pipe and the other roller being located below said outer pipe, both rollers being drivable by said pipe drive mechanism to move said concentric pipe member.

16. The method of claim 12, wherein said nozzle is a Penberthy nozzle.

17. The method of claim 16, wherein a plurality of different nozzles are provided, said nozzles being interchangeably attachable to said inner pipe distal end.

18. The method of claim 12, further including a solids grinder mechanism, said grinder mechanism being located in communication with an outflow from said outer pipe and operating said grinder mechanism to reduce the size of particulate material entrained in said outflow.

19. The method of claim 12, further including a ranging apparatus, and emplacing said ranging apparatus within the container and operating said ranging apparatus to penetrate to the surface of a sediment deposit in the bottom of the container, and a controller for said ranging apparatus to operate said ranging apparatus in a manner to generate a topographical representation of said sediment deposit.
